(19) United States
(12) Patent Application Publication
(10) Pub. No.: US 2017/0098203 A1
(43) Pub. Date: Apr. 6, 2017

(54) UNIVERSAL TRANSACTION PROCESSING

(71) Applicant: OneNetworks, Inc., San Mateo, CA (US)

(72) Inventor: Ernest Rolfson, San Mateo, CA (US)

(73) Assignee: OneNetworks, Inc., San Mateo, CA (US)

(21) Appl. No.: 15/284,366

(22) Filed: Oct. 3, 2016

Related U.S. Application Data
(60) Provisional application No. 62/236,393, filed on Oct. 2, 2015.
(60) Provisional application No. 62/236,813, filed on Oct. 2, 2015.

(51) Int. Cl. G06Q 20/10; G06Q 20/38

(52) U.S. Cl. CPC G06Q 20/102; G06Q 20/382

(57) ABSTRACT

Routing business-to-business money transfers to a specific payee associated with a specific payment processing network. A payment file is used to identify a payment processing network system associated with a payee. One or more payment channels of the payment processing network system are selected. The payment processing network system is instructed to transfer, using a financial institution system, the amount of the money transfer to the payee using the one or more payment channels.

### CROSS-REFERENCE TO RELATED APPLICATIONS

The present application claims priority to provisional U.S. Provisional Patent Application No. 62/236,813, filed on Oct. 2, 2015, and to provisional U.S. Provisional Patent Application No. 62/236,393, filed Oct. 2, 2015. The contents of the foregoing patent applications are hereby incorporated by reference as if set forth fully herein.

### BACKGROUND

Though electronic payment technologies (such as mobile payment technologies) have become popular for many transactions involving customers, electronic payment technologies have not evolved to support universal transaction processing. Making an electronic payment between a payment company (such as an outsourced Accounts Payable company) and a vendor may be expensive and complex. Furthermore, electronic payments involving credit card systems may include fees Automated Clearing House (ACH) systems, etc. that are complex or require extensive manual operation.

Systems involving High Ticket Interchange Rates (HTTR) may be useful for large transfers or transactions in which banks and customers opt into, but may not be cost-efficient. Moreover, systems involving payment gateways may require merchant sign-ins and may only be compatible with limited numbers of distributors, thereby decreasing efficiency. Digital wallet systems may present large transaction fees and may have little merchant presence, and may be focused on consumers and mobile payments, not business-to-business payments.

### SUMMARY

The techniques described herein may provide a payer interface implemented as a single, universal Application Programming Interface (API) that receives requests to transfer money from a payer and intelligently identifies the payee, as well as financial institutions and payment processing networks associated with the payee. Identifiers may be gathered and incorporated into the payee interface, which in some implementations, is provided as a mobile application, a webpage, a networked application, or other cloud-delivered application to a business-to-business payer system associated with the payer. Techniques for routing business-to-business money transfers to a specific payee associated with a specific payment processing network may involve receiving information related to a business-to-business transaction involving money transfer from a payer to a payee. A payment processing network system may be instructed to transfer, using a financial institution system, the amount of the money transfer to the payee using the one or more payment channels.

### BRIEF DESCRIPTION OF THE DRAWINGS

FIG. 1 is a diagram showing an example of a universal transaction processing environment.

FIG. 2 is a diagram showing an example of a data flow in a universal transaction processing environment.

FIG. 3 is a diagram showing an example of a data flow in a universal transaction processing environment.

FIG. 4A is a diagram showing an example of a data flow in a universal transaction processing environment.

FIG. 4B is a diagram showing an example of a data flow in a universal transaction processing environment.

FIG. 5 is a diagram showing an example of an automated payments processing hub system.

FIG. 6 is a diagram showing an example of a payment interface management engine.

FIG. 7 depicts a flowchart of an example of a method of facilitating access to one of a plurality of payment processing networks using a payer interface.

FIG. 8 depicts a flowchart of an example of a method of setting up a payer account to access a payer interface.

FIG. 9 depicts a flowchart of an example of a method of routing money for a business-to-business transaction over one or more payment processing network systems.

FIG. 10 depicts a flowchart of an example of a method of allowing a business-to-business payer to provide money for a business-to-business transaction over one or more payment processing network systems.

FIG. 11 depicts a flowchart of an example of a method of allowing a business-to-business payee to receive money for a business-to-business transaction over one or more payment processing network systems.

FIG. 12 is a diagram showing an example of a computer system.

FIG. 13A depicts a flowchart of an example of a method of directing payments from a accounts payable/procurement software platform to one or more suppliers and/or one or more acquirers.

FIG. 13B depicts a flowchart of an example of a method of directing payments from a accounts payable/procurement software platform to one or more suppliers and/or one or more acquirers.

FIG. 14A depicts a flowchart of an example of a method of directing payments from a buyer to one or more merchants.

FIG. 14B depicts a flowchart of an example of a method of directing payments from a buyer to one or more merchants.

### DETAILED DESCRIPTION

### Example Structures in a Universal Transaction Processing Environment

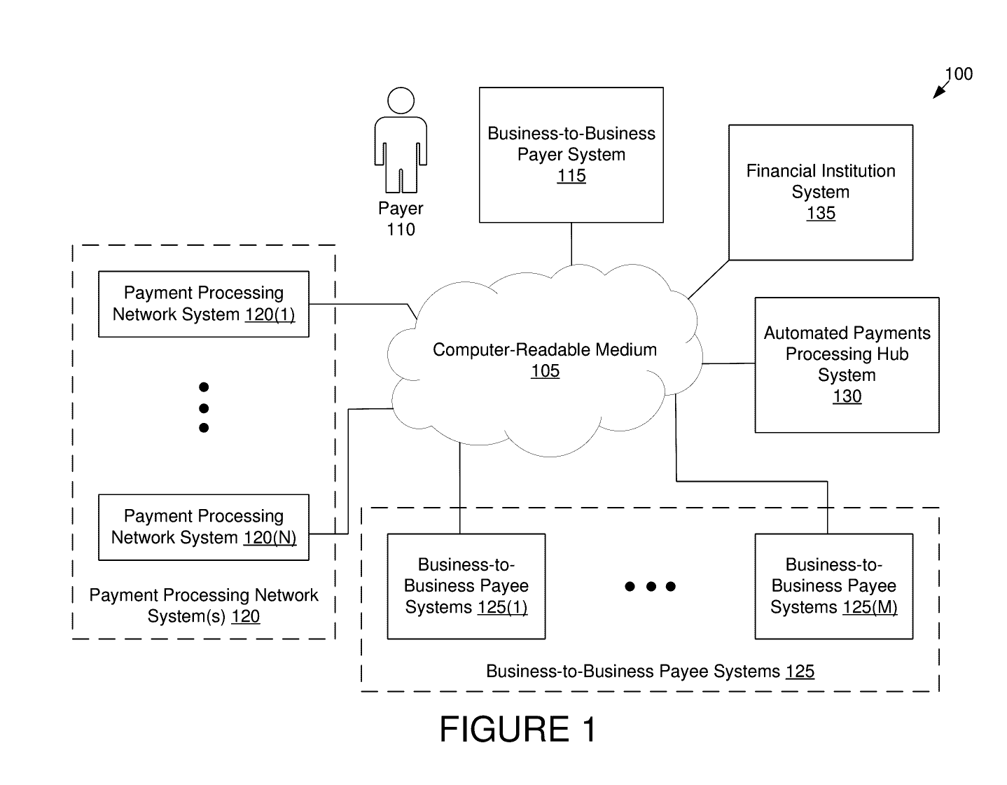

FIG. 1 is a diagram 100 showing an example of a universal transaction processing environment. The diagram 100 includes a computer-readable medium 105, a payer 110, a business-to-business payer system 115, one or more payment processing network system(s) 120 (including a first payment processing network system 120(1) through an Nth payment processing network system 120(N)), one or more business-to-business payee systems 125 (including a first business-to-business payee systems 125(1) through an Mth business-to-business payee systems 125(M)), an automated payments processing hub system 130, and one or more financial institution system(s) 135.

In the example of FIG. 1, the computer-readable medium 105 is coupled to the business-to-business payer system 115, the payment processing network system(s) 120, the business-to-business payee system(s) 125, the automated payments processing hub system 130, and the financial institution system(s) 135.

As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The computer-readable medium 105 is intended to represent a variety of potentially applicable technologies. For example, the computer-readable medium 105 can be used to form a network or part of a network. Where two components are co-located on a device, the computer-readable medium 105 can include a bus or other data conduit or plane. Where a first component is co-located on one device and a second component is located on a different device, the computer-readable medium 105 can include a wireless or wired back-end network or LAN. The computer-readable medium 105 can also encompass a relevant portion of a WAN or other network, if applicable.

The computer-readable medium 105 and other applicable systems or devices described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes at least two components: 1) a dedicated or shared processor, and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In the example of FIG. 1, the payer 110 is intended to represent a person (though it could be an automated agent of a person, business, entity, etc.) associated with the business-to-business payer system 115. The business-to-business payer system 115 can be associated with, for example, a print shop, a lumber yard, a mechanic, a restaurant, a bank, etc. that is part of a business-to-business transaction. In the illustrative examples that follow, the payer 110 makes a business-to-business payment between the business-to-business payer system 115 and the business-to-business payee system 125.

In the example of FIG. 1, the business-to-business payer system 115 is intended to represent a computer system configured to receive payments from the payer 110. In various implementations, the business-to-business payer system 115 includes a mobile phone, a tablet computing device, a laptop computer, a desktop computer, a dedicated or shared server, or some other applicable computer.

In the example of FIG. 1, the payment processing network system(s) 120 are intended to represent one or more computer systems configured to transmit payments from the business-to-business payer system 115 to the business-to-business payer system(s) 125 over a medium, such as the computer-readable medium 105. Each of the payment processing network system(s) 120 may be characterized by one or more payment modalities. As an example, each of the payment processing network system(s) 120 may be characterized as card or non-card electronic transfer based mechanisms that access disparate payment networks. Payment modalities include, for example, Automated Clearing House (ACH), Personal Identification Number (PIN) debit, private network, check, card, or other payment modalities. In various implementations, the payment processing network system(s) 120 include a mobile phone, a tablet computing device, a laptop computer, a desktop computer, a dedicated or shared server, or some other applicable computer. In some implementations, the payment processing network system(s) 120 are maintained by one or more existing processing networks and/or merchant processors (e.g., First Data STAR, Vantiv Jeanie, U.S. Bank Blavon, Discover Pulse, etc.).

In the example of FIG. 1, the business-to-business payee system(s) 125 are intended to represent one or more computer systems configured to process information related to payments from the payment processing network system(s) 120. In various implementations, the business-to-business payee system(s) 125 include a mobile phone, a tablet computing device, a laptop computer, a desktop computer, a dedicated or shared server, or some other applicable computer. In some implementations, the business-to-business payee system(s) 125 are associated with specific payees, such as entities that are receiving payments for goods or services from the payer 110 using transfers managed by the payment processing network system(s) 120.

In the example of FIG. 1, the automated payments processing hub system 130 is intended to represent one or more computer systems configured to receive information related to a business-to-business transaction between the business-to-business payer system 115 and the business-to-business payee system(s) 125 over the payment processing network system(s) 120. For example, the automated payments processing hub system 130 may select specific payment processing network system(s) 120 associated with a particular payee using on a database of payment networks associated with that payee. In various implementations, the automated payments processing hub system 130 includes a mobile phone, a tablet computing device, a laptop computer, a desktop computer, a dedicated or shared server, or some other applicable computer.

In the example of FIG. 1, the financial institution system(s) 135 is intended to represent one or more computer systems typically maintained by a bank, credit institution, or other financial institution. For illustrative purposes, the financial institution system(s) 135 are associated with the payer 110. The financial institution system(s) 135 may also be associated with a financial institution that provides financial services to multiple payers, multiple payees, and/or one or more intermediaries between the payers and payees. Although FIG. 1 shows the financial institution system(s) 135 as comprising a single system, it is noted that the financial institution system(s) 135 may include systems of a single financial entity or multiple financial entities. The financial institutions associated with the financial institution system(s) 135 may vary in structure, size, scope, and other parameters. In some implementations, one or more of the financial institutions are configured to reconcile payments between one another over the payment processing network system(s) 120. In various implementations, the financial institution system(s) 135 include a mobile phone, a tablet computing device, a laptop computer, a desktop computer, a dedicated or shared server, or some other applicable computer.

### The Universal Transaction Processing Environment in Operation

The universal transaction processing environment shown in the diagram 100 may operate to provide payments companies with: growth in electronic payment adoptions, incremental revenue, elimination of manual check processing, greater security, greater flexibility, stronger value propositions, etc.; operate to provide merchant processors with transaction growth, incremental increases in electronic payment revenues, non-disruption of existing customer bases, attraction of new customers, increases in customer loyalty, etc.; operate to provide payees with faster payment, the ability to receive automated deposits (e.g., direct deposits) in business-to-business transactions, and the ability to maintain relationships with existing payment processing network systems; operate to allow merchant processors to increase rates of electronic payments, particularly compared to transactions involving paper checks; and operate to provide payment systems that are infinitely scalable as additional payers, payees, and payment processing systems are added to the ecosystem.

FIG. 1 is intended to illustrate an environment in which intelligent cloud-based network(s) enable frictionless commercial payments. This can be enabled with a network of networks formed using a universal, automated, cloud-based Application Programming Interface (API) that establish a central hub or database of several payment processing networks that exist in the broader financial services landscape. The universal API facilitates the use of a unified and low-cost payment system, enables linking of several payment processing networks so that payments can be automated without any vendor involvement, and leverages existing relationships between the business-to-business payee system(s) 125 and the payment processing network system(s) 120 to facilitate fund transfers with low transaction costs that avoid establishing direct connections between the business-to-business payee system(s) 125 and the payment processing network system(s) 120.

In a specific implementation, the business-to-business payer system 115 receives information related to a business-to-business transaction from the payer 110. For example, the business-to-business payer system 115 may receive the identify of a payee and a specific amount that the payer 110 wishes to transfer to the payee for a good or a service. In a specific implementation, the business-to-business payer system 115 provides information related to the business-to-business transaction to the automated payments processing hub system 130 over the computer-readable medium 105. For example, the business-to-business payer system 115 may use an application, process, etc. to provide the information related to the business-to-business transaction over the computer-readable medium 105.

In a specific implementation, the automated payments processing hub system 130 identifies the payee (e.g., identifies specific business-to-business payee system(s) 125) and the amount to be sent for the business-to-business transaction. The automated payments processing hub system 130 may further identify specific payment processing network system(s) 120 associated with the payee, and may route a request to make a payment to the identified payment processing network system(s) 120. The automated payments processing hub system 130 may or may not establish a direct connection with the payer 110 (e.g., with bank account routing information etc.).

In a specific implementation, the automated payments processing hub system 130 selects payment modalities (Virtual Card, ACH, PIN, etc.) for the identified payment processing network system(s) 120. The automated payments processing hub system 130 can provide new and cost-efficient access points through existing payment rails maintained by the payment processing network system(s) 120. For example, instead of leveraging high cost payment networks (e.g., Visa and MasterCard networks), the automated payments processing hub system 130 may move payments from the payer 110 to the payee via existing networks in private transactions for automated, low transaction-cost payments that have been negotiated between a payee and an identified payment processing network system 120.

In a specific implementation, the automated payments processing hub system 130 incorporates dynamic pricing capabilities. For example, the automated payments processing hub system 130 may price a transaction based on the cost to the payer 110, the payee, and/or the cost of identified payment processing network system(s) 120 associated with the payee. Although FIG. 1 and the description in this paper discuss the automated payments processing hub system 130 as distinct from the payment processing network system(s) 120, it is noted that, the automated payments processing hub system 130 and the payment processing network system(s) 120 could be managed by a single or by associated entities.

In a specific implementation, the automated payments processing hub system 130 provides the ability to collect data (e.g., perform rich data collection) related to business-to-business transactions between the business-to-business payer system(s) 115 and the business-to-business payer system(s) 125. For example, the automated payments processing hub system 130 may operate to track business-to-business transactions, thereby presenting numerous advantages over paper check payment mechanisms.

In a specific implementation, the automated payments processing hub system 130 may provide a payer interface implemented as a single, universal Application Programming Interface (API), to facilitate access to one or more of the payment processing network system(s) 120 and allow the business-to-business payer system 115 to transfer money to the business-to-business payee system(s) 125. For example, the single, universal API may receive requests to transfer money from the business-to-business payer system 115, intelligently identify a payee associated with the business-to-business payer system 115, and/or identify one or more of the payment processing network system(s) 120 associated with the business-to-business payee system(s) 125. In a specific implementation, the automated payments processing hub system 130 gathers one or more identifiers (payee identifiers, payee financial institution identifiers, payment processing network identifiers, payment processing network routing information, etc.) and/or incorporate these identifiers into its payee interface. In various implementations, the automated payments processing hub system 130 may provide the payee interface as a mobile application, a webpage, a networked application, or other cloud-delivered application to the business-to-business payer system(s) 125. In a specific implementation, the automated payments processing hub system 130 may receive over the payer interface one or more of: payer identification information, payee identification information, and a transfer amount of a money transfer between the payer and the payee.

The automated payments processing hub system 130 may operate to route business-to-business money transfers to a specific payee over a specific one of the payment processing network(s) 125. In a specific implementation, the automated payments processing hub system 130 processes a payment file that identifies a payee and a money transfer amount. For example, the payment file may be used to identify a payment processing network system associated with the payee. One or more payment channels of the payment processing network system may be selected using the payment file. The automated payments processing hub system 130 may instruct one or more of the payment processing network system(s) 120 to transfer, using/through/via/etc. the financial institution system 135, the amount of the money transfer to the business-to-business payee system(s) 125 using the one or more payment channels that were identified. The automated payments processing hub system 130 may provide the business-to-business payer system 115 with a confirmation whether or not the amount was transferred to the relevant business-to-business payee system(s) 125. In various implementations, the automated payments processing hub system 130 receives a payment by (without limitation) performing one or more of: receiving a request to accept a money transfer from the business-to-business payee system(s) 125; providing instructions to accept the request; identifying an amount of the money transfer; identifying a financial institution system 135 having funds for the money transfer; receiving the money transfer over one or more payment channels of a the payment processing network system(s) 120; and providing instructions to the financial institution system 135 to reconcile the business-to-business payer system 115 (and/or a payer account associated with that system) for the amount of the money transfer.

### Example Data Flows

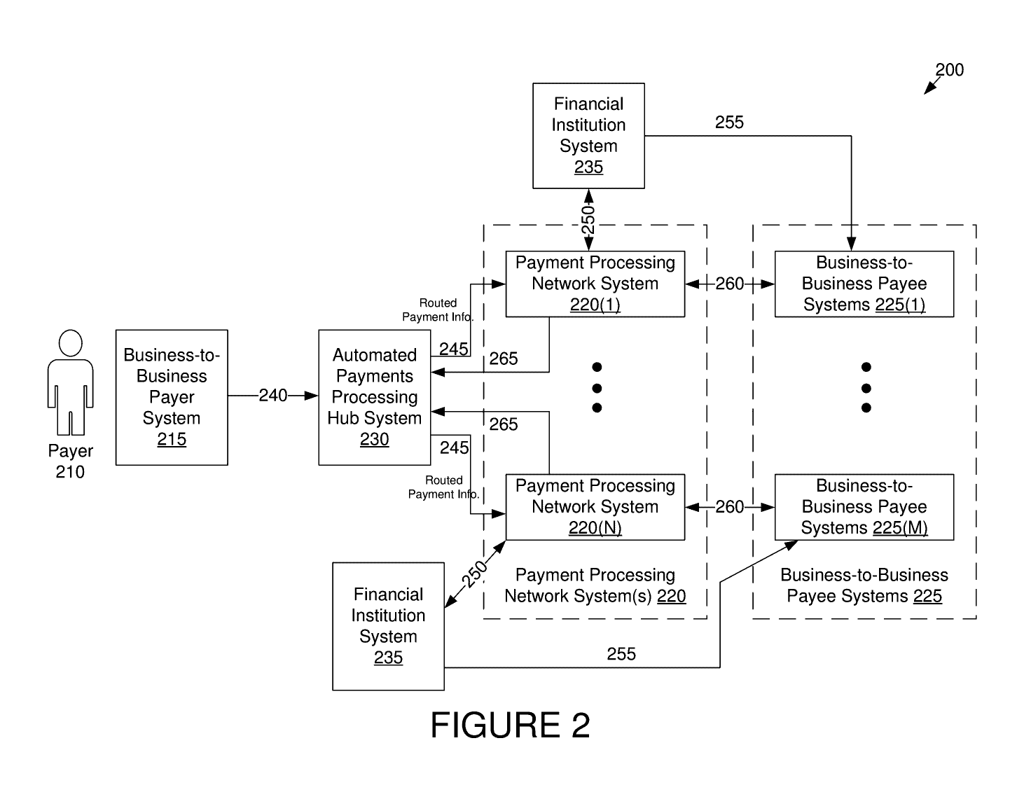

FIG. 2 is a diagram 200 showing an example of a data flow in a money transfer environment. The diagram 200 includes a payer 210, a business-to-business payer system 215, an automated payments processing hub system 230, one or more payment processing network system(s) 220, financial institution system(s) 235, one or more business-to-business payee system(s) 225. Operation 240 is intended to represent the business-to-business payer system 215 provides the automated payments processing hub system 230 information related to a business-to-business transaction between the payer 210 and a payee. The automated payments processing hub system 230 may identify a payee and an amount of the business-to-business transaction. In some implementations, the automated payments processing hub system 230 identifies specific payment processing network systems for the identified payee.

Operation 245 is intended to represent the automated payments processing hub system 230 provides instructions to identified payment processing network system(s) 220 to transfer the amount to respective payee(s). The payment processing network system(s) 220 may gather the necessary funds from bank accounts, credit institutions, financial institutions, etc. associated with the payer 210. Operation 250 is intended to represent the payment processing network system(s) 220 provides instructions the financial institution system(s) 235 to provide the amount of the business-to-business transaction to the business-to-business payee system(s) 225. Operation 255 is intended to represent the financial institution system(s) 235 provides the amount of the transfer to the business-to-business payee system(s) 225. Operation 260 is intended to represent the payment processing network system(s) 220 receives confirmation or denial of whether the payment from the financial institution system(s) 235 was successful. Operation 265 is intended to represent the payment processing network system(s) 220 provides confirmation or denial of whether the payment from the financial institution system(s) 235 was successful to the automated payments processing hub system 230.

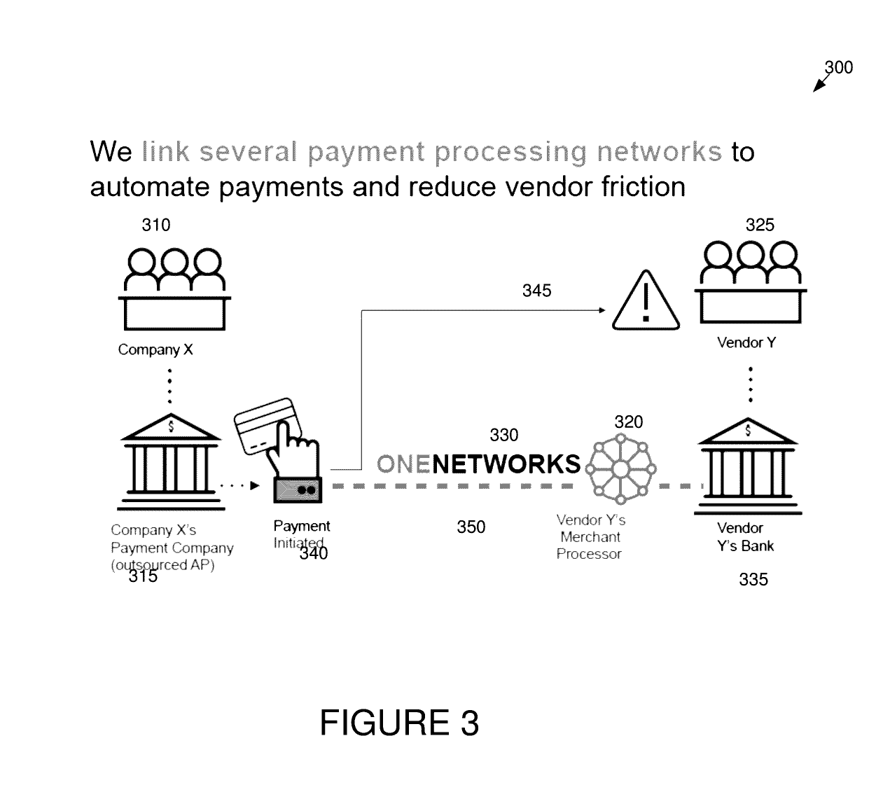

FIG. 3 is a diagram 300 showing an example of a data flow in a universal transaction processing environment. The diagram 300 includes a payer 310, a business-to-business payer system 315, an automated payments processing hub system 330, a payment processing network system 320, a business-to-business payee system 325, and a financial institution system 335. Point 340 is intended to represent an electronic payment is initiated. Point 345 is intended to represent the business-to-business payee system 225 cannot directly accept the electronic payment. Point 350 is intended to represent information related to the electronic payment is provided to the payment processing network system 320, which in turn instructs the financial institution system 335 to transfer funds to the business-to-business payee system 325. Point 355 is intended to represent attribution of the transfer by the financial institution system 335 to the business-to-business payee system 325.

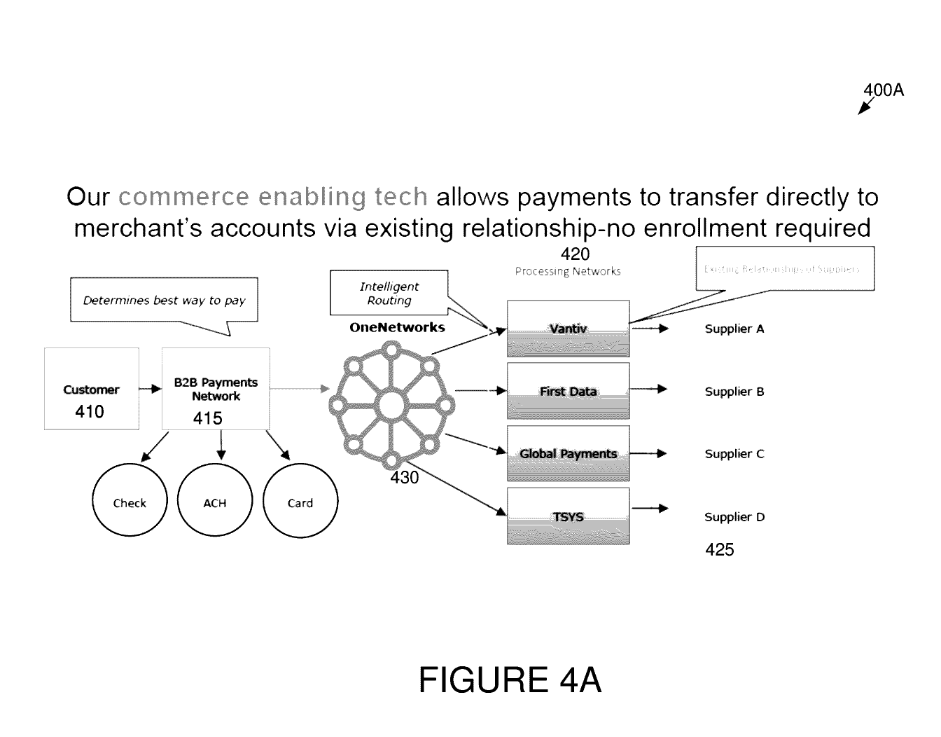

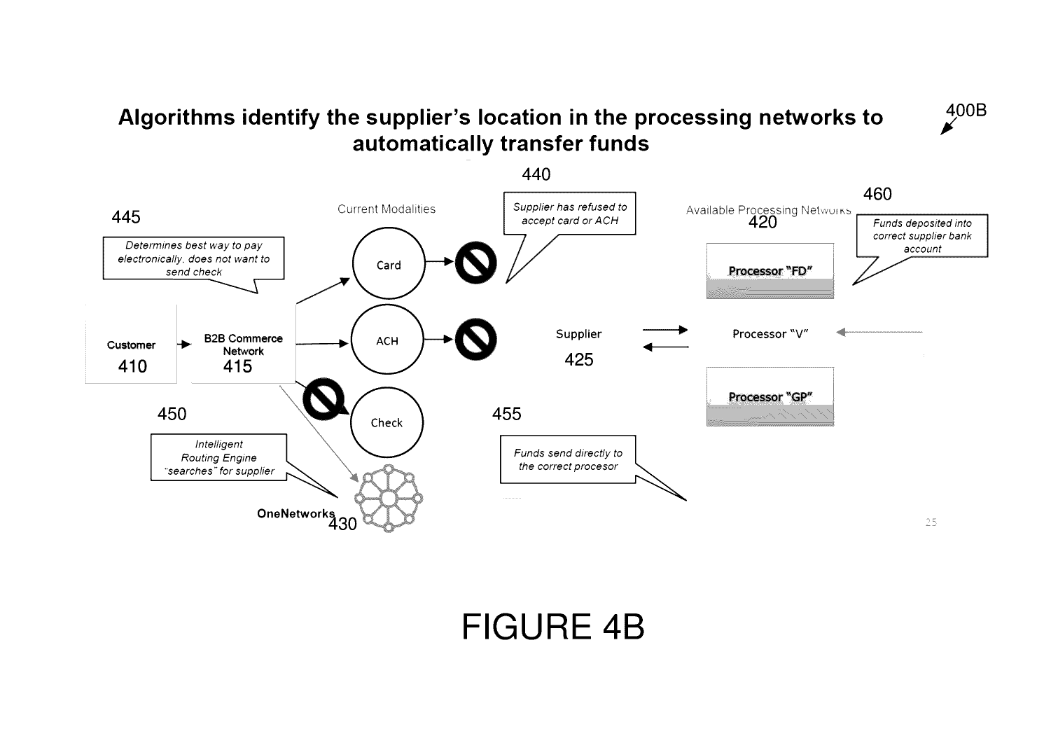

FIG. 4A is a diagram 400A showing an example of a data flow in a universal transaction processing environment. The diagram 400A includes a payer 410, a business-to-business payer system 415, an automated payments processing hub system 430, payment processing network system(s) 420, and business-to-business payee system(s) 425. In a specific implementation, the business-to-business payer system 415 may determine the best way to pay. The automated payments processing hub system 430 may select and route to specific payment processing network system(s) 420 for the transaction. The payment processing network system(s) 420 may provide instructions to the business-to-business payee system(s) 425 and/or financial institution systems to satisfy the transaction.

FIG. 4B is a diagram 400B showing an example of a data flow in a money transfer environment. The diagram 400A includes a payer 410, a business-to-business payer system 415, an automated payments processing hub system 430, payment processing network system(s) 420, and business-to-business payee system(s) 425. Point 440 is intended to represent the suppler 425 has refused to accept card or ACH. Point 445 is intended to represent the business-to-business payer system 415 determines the best way to pay is electronically, not using a check. Point 450 is intended to represent the automated payments processing hub system 430 searches for the business-to-business payee system(s) 425. Point 455 is intended to represent the payment processing network system(s) 420 provide instructions to transfer the amount of the business-to-business transaction to the business-to-business payee system(s) 425. Point 460 is intended to represent the payment processing network system(s) 420 coordinates sending the amount to the business-to-business payee system(s) 425 using instructions to one or more financial institution systems.

### Example Universal Transaction Processing Hub System

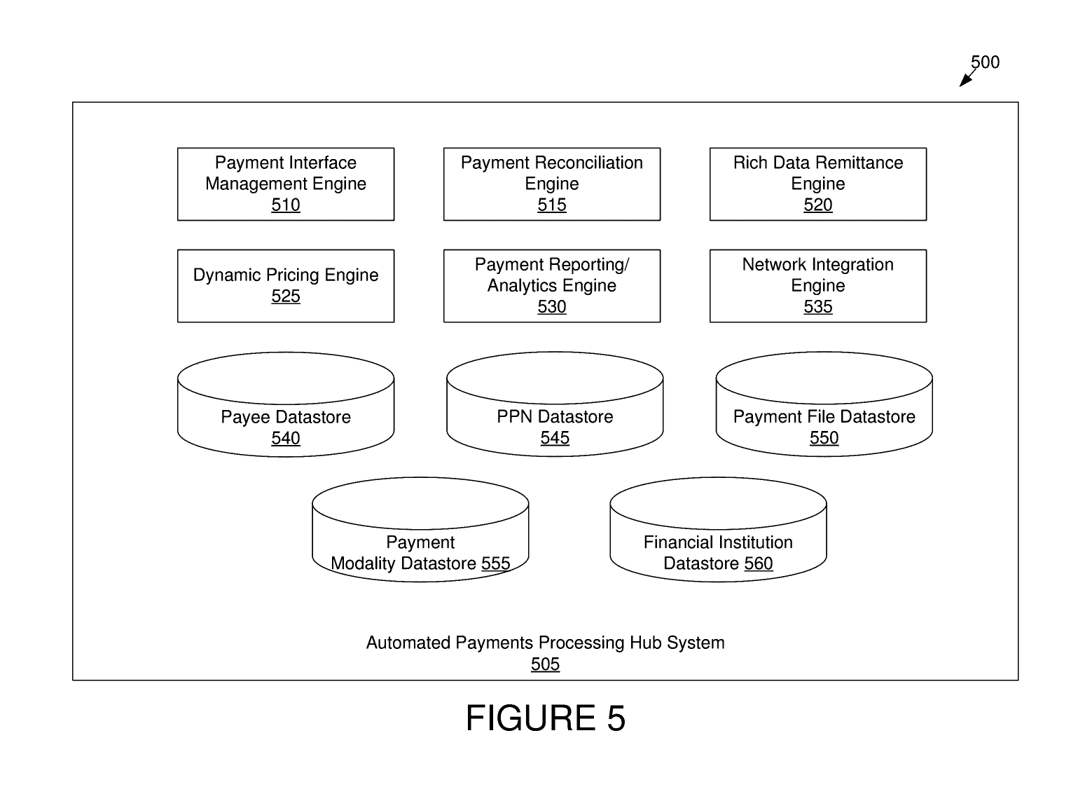

FIG. 5 is a diagram 500 showing an example of an automated payments processing hub system 505. In the diagram 500, the automated payments processing hub system 505 includes a payment interface management engine 510, a payment reconciliation engine 515, a rich data remittance engine 520, a dynamic pricing engine 525, a payment reporting/analytics engine 530, a network integration engine 535, a payee datastore 540, a payment processing network datastore 545, a payment file datastore 550, a payment modality datastore 555, and a financial institution datastore 560.

In a specific implementation, the payment interface management engine 510 identifies payees by gathering identifiers of one or more payees from the payee datastore 540. Payees may be indexed by name, username, email address, identification number (social security number, government identification number), biometric identifier, and/or other identifier. In a specific implementation, the payment interface management engine 510 identifies payment processing networks associated with a payee by gathering identifiers of payment processing networks stored in the payment processing network datastore 545. Payment processing networks may be indexed by name, account and/or money transfer information (e.g., parameters of a payment processing network used to process payments between financial institutions), and/or other identifiers. The payment interface management engine 510 may provide identifiers of payees and/or payment processing networks to the other modules of the automated payments processing hub system 505.

In some implementations, the payment reconciliation engine 515 reconciles payments with payers, financial institutions, payment processing networks, and/or payees. The payment reconciliation engine 515 may provide instructions to financial institution systems to transfer money from payer accounts, provide instructions to financial institution systems to make deposits to payee accounts, and/or provide instructions to financial institutions systems to reconcile amounts owed one another due to a transfer from a payer account to a payee account. In various implementations, the payment reconciliation engine 515 interfaces with one or more ACH networks to effect a transfer of funds between financial institution systems. More particularly, the payment reconciliation engine 515 may provide ACH networks with instructions to transfer funds to/from various financial institution systems. The payment reconciliation engine 515 may allow selection of one or more payment modalities, e.g., methods of payment, from the payment modality datastore 555. The payment reconciliation engine 515 may gather payee information from a payee file stored on the payment file datastore 550. In various implementations, the payment reconciliation engine 515 identifies a financial institution using identifiers of financial institutions stored in the financial institution datastore 560.

In a specific implementation, the rich data remittance engine 520 provides rich data related to a business-to-business transaction between a business-to-business payer and a business-to-business payee. “Rich data,” as used herein, may refer to any data used to provide a payer system or a payee system with contextual information related to a business-to-business transaction. Rich data may comprise visual data, such as images, charts, graphs, and videos. Rich data may comprise metadata, which in turn may include any data for depicting a business-to-business transaction on a payer system or a payee system. In some implementation, the rich data remittance engine 520 supports a mobile application, webpage, etc. on a payer system and/or payee system that depicts a business-to-business transaction. The rich data remittance engine 520 may receive rich data from one or more financial institution systems, that is, the rich data remittance engine 520 may be informed by rich data provided by one or more financial institutions systems that allow a business-to-business transaction to be depicted on a payer system/payee system in a user-friendly and/or user-accessible manner.

In some implementations, the dynamic pricing engine 525 dynamically identifies transaction fees for a business-to-business transaction. “Dynamically” identifying a fee, as used herein, may comprise identifying a fee of a transaction while the transaction is pending and/or otherwise underway. The dynamic pricing engine 525 may obtain transaction fees of respective financial institutions from financial institution systems associated with payers, payees, etc. In some implementations, the dynamic pricing engine 525 estimates and/or approximates transaction fees of financial institutions based on likely costs of a business-to-business transaction between a known payer and a known payee. As an example, the dynamic pricing engine 525 may estimate fees between financial institutions. As another example, the estimate transaction fees of international transactions based on known exchange rates and/or known costs of transferring money between two jurisdictions. As yet another example, the dynamic pricing engine 525 may estimate sales taxes for a specific jurisdiction. As yet another example, the dynamic pricing engine 525 may estimate and/or approximate labor, environmental, shipping, and/or costs associated with a specific business-to-business transaction. The dynamic pricing engine 525 may provide dynamically identified transaction fees to one or more other modules of the automated payments processing hub system 505.

In a specific implementation, the payment reporting/analytics engine 530 provides reports and analytics of business-to-business transactions. The network integration engine 535 may interface with payment processing network systems; may manage packet or other level instructions to payment processing network systems; and/or may interface with an ACH or other network by providing packet or other level instructions to that network.

In a specific implementation, the payee datastore 540 stores information related to payees, such as payees' identities and payment processing networks associated with payees; the payment processing network datastore 545 stores information related to payment processing network systems; the payment file datastore 550 stores information related to payment files (which in turn may store identities of payees and/or amounts of payments); the payment modality datastore 555 stores information related to payment modalities; and the financial institution datastore 560 stores information related to financial institution systems.

### Example Universal Transaction Payment Interface Management System

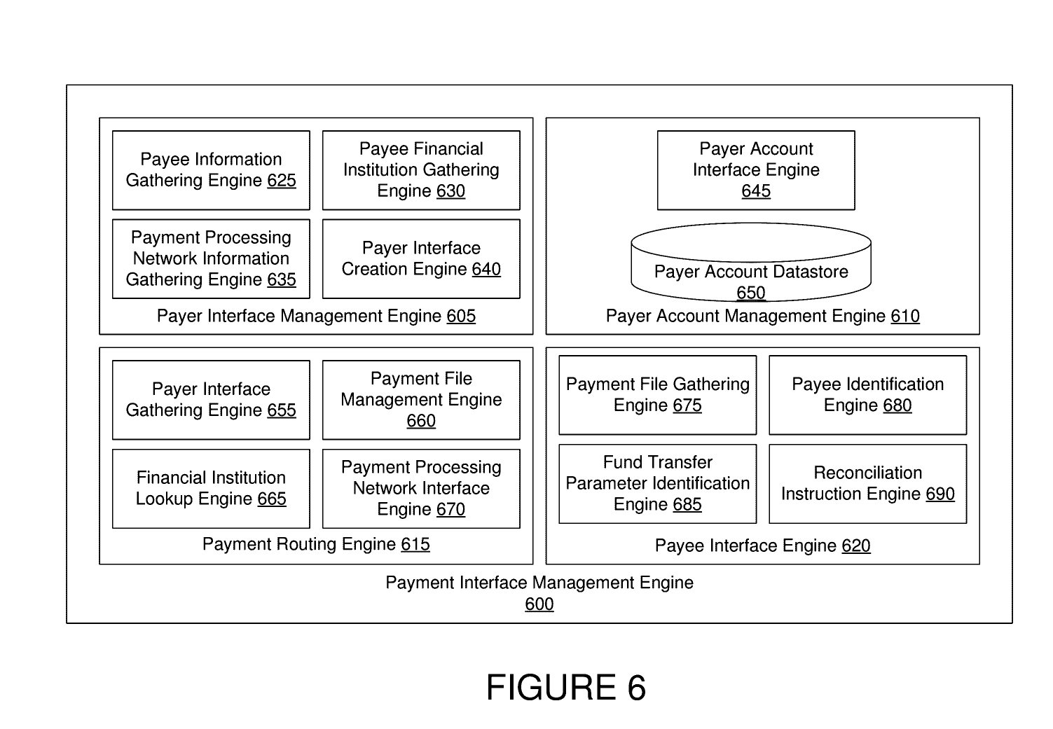

FIG. 6 is a diagram 600 showing an example of a payment interface management engine 600. In the diagram 600, the payment interface management engine 605 includes a payer interface management engine 605, a payer account management engine 610, a payment routing engine 615, and a payee interface engine 620.

In a specific implementation, the payer interface management engine 605 is configured to interface with a business-to-business payer system. In the diagram 600, the payer interface management engine 605 includes a payee information gathering engine 625, a payee financial institution gathering engine 630, a payment processing network information gathering engine 635, and a payer interface creation engine 640. The payee information gathering engine 625, the payee financial institution gathering engine 630, the payment processing network information gathering engine 635, and the payer interface creation engine 640 may be coupled to one another or to modules not explicitly shown in FIG. 6.

In a specific implementation, the payee information gathering engine 625 is configured to gather identifiers of payee systems, such as business-to-business payee systems. The payee information gathering engine 625 may obtain usernames, email addresses, login credentials, etc. of payees of a business-to-business money transfer. The payee information gathering engine 625 may support one or more interfaces (e.g., APIs) to payee systems. The payee information gathering engine 625 may provide identifiers of payee systems to one or more other modules of the payment interface management engine 600.

In a specific implementation, the payee financial institution gathering engine 630 is configured to gather identifiers of payee financial institution systems. The payee financial institution gathering engine 630 may identify credentials used by a payee financial institution to access a payment processing network, such as a relevant ACH network used to facilitate transfers between a payer financial institution and other financial institutions (e.g., payer financial institutions).

In a specific implementation, the payment processing network information gathering engine 635 is configured to gather identifiers of payment processing networks used to transfer funds from a business-to-business payer to a business-to-business payee. The payment processing network information gathering engine 635 may be configured to gather payment processing network names/identifiers, payment processing network access information (account names, passwords, etc.), and/or other information used to access a payment processing network. The payment processing network information gathering engine 635 may provide identifiers of payment processing networks to other modules, such as the payer interface creation engine 640.

In a specific implementation, the payer interface creation engine 640 is configured to create a payer interface. The payer interface may comprise portions of an application (standalone application, networked application, mobile application, etc.). The payer interface may facilitate selection of a payment processing network. The payer interface may process (receive and/or provide) instructions to a payment processing network to transfer a specific amount of money from one financial institution to another. In various implementations, the payer interface provides a payment processing network with identifiers of financial institutions implicated in a fund transfer.

In a specific implementation, the payer account management engine 610 is configured to manage payer accounts. In the diagram 600, the payer account management engine 610 includes a payer account interface engine 645 and a payer account datastore 650. In a specific implementation, the payer account interface engine 645 is configured to manage creation and/or other management of payer accounts. In a specific implementation, the payer account datastore 650 is configured to store information related to payer accounts (usernames, passwords, access parameters, etc.).

In a specific implementation, the payment routing engine 615 is configured to manage routing of payments through one or more payment processing networks identified by modules of the payment interface management engine 600 (e.g., the payer interface management engine 605). In the diagram 600, the payment routing engine 615 includes a payer interface gathering engine 655, a payment file management engine 660, a financial institution lookup engine 665, and a payment processing network interface engine 670.

In a specific implementation, the payer interface gathering engine 655 is configured to gather payer interfaces created and/or managed by the payer interface management engine 605. In some implementations, the payer interface gathering engine 655 receives classes, objects, and/or other identifiers of payer interfaces. The payer interface gathering engine 655 may provide information about payer interfaces to one or more of the other modules of the payment interface management engine 600.

In a specific implementation, the payment file management engine 660 is configured to manage payment files. The payment file management engine 660 may create and/or otherwise allow edits to payment files in a payment file datastore. The payment file management engine 660 may receive instructions to manage a payment file from other modules of the payment interface management engine 600. The payment file management engine 660 may modify payment files based on the instructions from the other modules of the payment interface management engine 600.

In a specific implementation, the financial institution lookup engine 665 is configured to look up financial institutions implicated in a business-to-business transfer. The financial institution lookup engine 665 may gather identifiers of financial institutions from a financial institution datastore or other relevant datastore. The financial institution lookup engine 665 may provide identifiers of financial institutions to the other modules of the payment interface management engine 600.

In a specific implementation, the payment processing network interface engine 670 is configured to interface with a payment processing network. The payment processing network interface engine 670 may be configured to identify, using a payment file, a payee of a business-to-business transaction. The payment processing network interface engine 670 may further provide instructions to effect a business-to-business money transfer.

In a specific implementation, the payee interface engine 620 is configured to interface with payees. In the diagram 600, the payee interface engine 620 includes a payment file gathering engine 675, a payee identification engine 680, a fund transfer parameter identification engine 685, and a reconciliation instruction engine 690. In a specific implementation, the payment file gathering engine 675 is configured to gather a payment file from a payment file datastore. In a specific implementation, the payee identification engine 680 is configured to identify a payee in a payment file associated with a business-to-business fund transfer. In a specific implementation, the fund transfer parameter identification engine 685 is configured to identify fund transfer parameters (fund amount(s), implicated financial institutions, etc.) of a business-to-business fund transfer. The fund amount identification may parse a payment file to obtain a fund amount of a business-to-business fund transfer. In a specific implementation, the reconciliation instruction engine 690 is configured to provide instructions to reconcile fund amounts transferred across a payment processing network.

### Example Operation of Universal Transaction Payment Interface Management System

The payment interface management engine 605 may operate to manage business-to-business money transfers from a payer to a payee, such as by facilitating access to one or more payment processing networks. In some implementations, the payee information gathering engine 625 may operate to gather one or more payee identifiers of business-to-business payee systems. Payee identifiers may include names, usernames, email addresses, unique identifiers, etc. of payees gathered from a payment file. The payee information gathering engine 625 may provide payee identifiers to other modules, such as the payee financial institution gathering engine 630. The payee financial institution gathering engine 630 may operate to gather a payee financial institution identifier of a payee financial institution. The payee financial institution may be configured to receive money transfers for the business-to-business payee systems. In various implementations, the payee financial institution gathering engine 630 may operate to gather financial institution names, identification codes, etc. The payment processing network information gathering engine 635 may operate to gather a payment processing network identifier of a payment processing network system. In various implementations, the payment processing network system is configured to route the money transfers to the payee financial institution. More particularly, the payment processing network system may be configured to provide (e.g., over an ACH network) fund amounts that a payer financial institution is to transfer to a payee financial institution. The payment routing engine 615 may operate to gather from the payment processing network system payee routing information. In various implementations, the payee routing information may specify a funds transfer mechanism for transferring the electronic funds from the payment processing network system to the payee financial institution. The funds transfer mechanism may comprise a specific ACH mechanism or other relevant funds transfer mechanism. The payer interface creation engine 640 may create a payer interface based on the information processed by other modules of the payer interface management engine 605. In some implementations, the payer interface creation engine 640 may incorporate payee identifiers, financial institution identifiers, payment processing network identifiers, the payee routing information, and/or other identifiers into a payer interface. The payer interface may be configured to receive a request to perform the money transfers from a business-to-business payer system.

The payer account management engine 610 may operate to create and/or otherwise manage payer accounts. The payer account interface engine 645 may gather payer information (names, email addresses, unique identifiers, access codes to financial institutions, etc.) from the payer account datastore 650. In some implementations, the payer account interface engine 645 receives an identifier (object identifier, class identifier, etc.) of a payer interface created by the payer interface management engine 605. The payer account interface engine 645 may process, from the payer interface, payer identification information for identifying a payer of a money transfer, payee identification information for identifying a payee of the money transfer, and a transfer amount of the money transfer. The payer account interface engine 645 may incorporate the payer information into a payer account data structure to be stored in the payer account datastore 650.

The payment routing engine 615 may operate to route business-to-business transactions to a specific payee associated with a specific payment processing network. In some implementations, the payer interface gathering engine 655 may operate to receive information related to a business-to-business transaction involving money transfer from a payer to a payee. The payer interface gathering engine 655 may gather this information from a payer interface, created by the payer interface management engine 605, and described further herein. The payment file management engine 660 may operate to receive a payment file from one or more other modules of the systems and methods described herein, such as a payment file datastore. In some implementations, the payment file may identify the payee and an amount of the money transfer. The payment file management engine 660 may identify, using the payment file, a payment processing network system associated with the payee. The payment file management engine 660 may provide this information to the financial institution lookup engine 665 and/or the payment processing network interface engine 670. The payment processing network interface engine 670 may operate to select one or more payment channels of the payment processing network system using the payment file. The payment processing network interface engine 670 may operate to instruct the payment processing network system to transfer, using a financial institution system, the amount of the money transfer to the payee using the one or more payment channels. In various implementations, the payer interface gathering engine 655 may provide a payer with a confirmation whether or not the amount was transferred to the payee.

The payee interface engine 620 may operate to allow payees to receive business-to-business payments. In various implementations, the payment file gathering engine 675 may gather a payment file from a payment file datastore. The payee identification engine 680 may receive (from a payee system) a request to accept a money transfer from a payer. The payee identification engine 680 may further provide instructions to accept the request. The fund transfer parameter identification engine 685 may identify one or more amounts of the money transfer. The fund transfer parameter may identify an amount of the money transfer and/or may identify a financial institution having funds for the money transfer. In some implementations, the reconciliation instruction engine 690 receives the money transfer over one or more payment channels of a payment processing system. The reconciliation instruction engine 690 may provide instructions to the financial institution to reconcile a payer account for the amount of the money transfer.

### Example Flowcharts of Methods of Operation

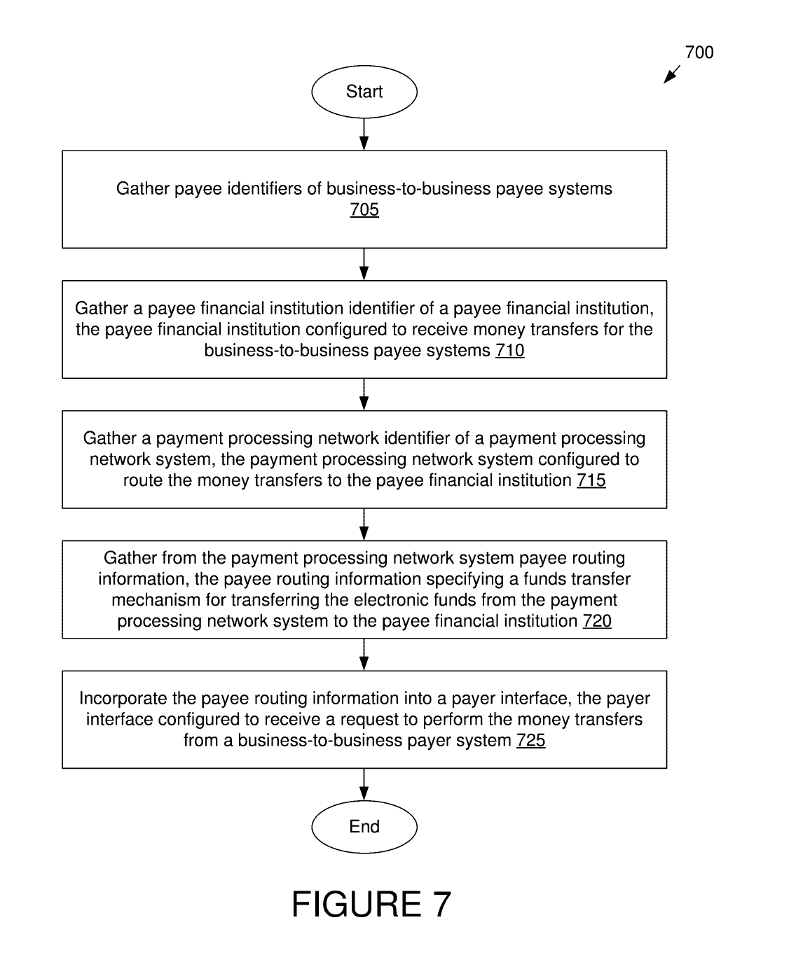

FIG. 7 depicts a flowchart 700 of an example of a method of facilitating access to one of a plurality of payment processing networks using a payer interface. The flowchart 700 is discussed in conjunction with the structures shown in FIG. 5 and FIG. 6. It is noted other structures may enable and/or provide written description for the operations of the flowchart 700. It is noted some implementations may include more or less conceptual or functional blocks than those shown in FIG. 7.

The flowchart 700 starts at block 705 where payee identifiers of business-to-business payee systems are gathered. In some implementations, the payee information gathering engine 625 may gather payee identifiers of business-to-business payee systems. Payee identifiers may comprise any relevant mechanism used to identify payees, including but not limited to payee usernames, payee email addresses, payee contact information, etc. In various implementations payee identifiers may be gathered from a payment file in a payment file datastore (e.g., the payment file datastore 550). The payee information gathering engine 625 may provide the payee identifiers to one or more of the other modules of the payment interface management engine 600.

The flowchart 700 continues to block 710 where a payee financial institution identifier of a payee financial institution is gathered. The payee financial institution may be configured to receive money transfers for the business-to-business payee systems. In some implementations, the payee financial institution gathering engine 630 may gather a payee financial institution identifier of a payee financial institution. The payee financial institution may receive money transfers for the business-to-business payee systems. For instance, the payee financial institution may comprise a bank, credit entity, other intermediary, etc. at which a payee maintains a financial account that the payee can make withdrawals from. The payee financial institution identifier may comprise a name, number (e.g., routing number), or other identifier used to identify the payee financial institution.

The flowchart 700 continues to block 715 where a payment processing network identifier of a payment processing network system is gathered. The payment processing network information gathering engine 635 may gather a payment processing network identifier of a payment processing network system, the payment processing network system configured to route the money transfers to the payee financial institution. The payment processing network identifier may comprise any format used to identify (e.g., uniquely identify) a payment processing network. The payment processing network identifier may comprise character strings, account (e.g., routing) numbers, etc.

The flowchart 700 continues to block 720 where payee routing information is gathered from the identified payment processing network. The payee routing information may specify a funds transfer mechanism for transferring the electronic funds from the payment processing network system to the payee financial institution. The payment routing engine 615 may gather payee routing information. for the transaction and may provide a funds transfer mechanism (e.g., specific routing numbers) for the funds transfer. The payment routing engine 615 may provide the payee routing information to the payment processing network information gathering engine 635 and/or other modules of the payer interface management engine 605.

The flowchart 700 continues to block 725 where the payee routing information is incorporated into a payee interface. The payee interface may be configured to receive a request to perform the money transfers from a business-to-business payer system. In some implementations, the payer interface creation engine 640 may operate to incorporate the payee routing information into a payer interface. The payer interface may comprise a webpage, a portion of a standalone application, a portion of a mobile application, etc. The payer interface configured to receive a request to perform the money transfers from a business-to-business payer system. More particularly, the payer interface may provide to payers a graphical user interface (GUI) that the payer can use to transfer money to a payee.

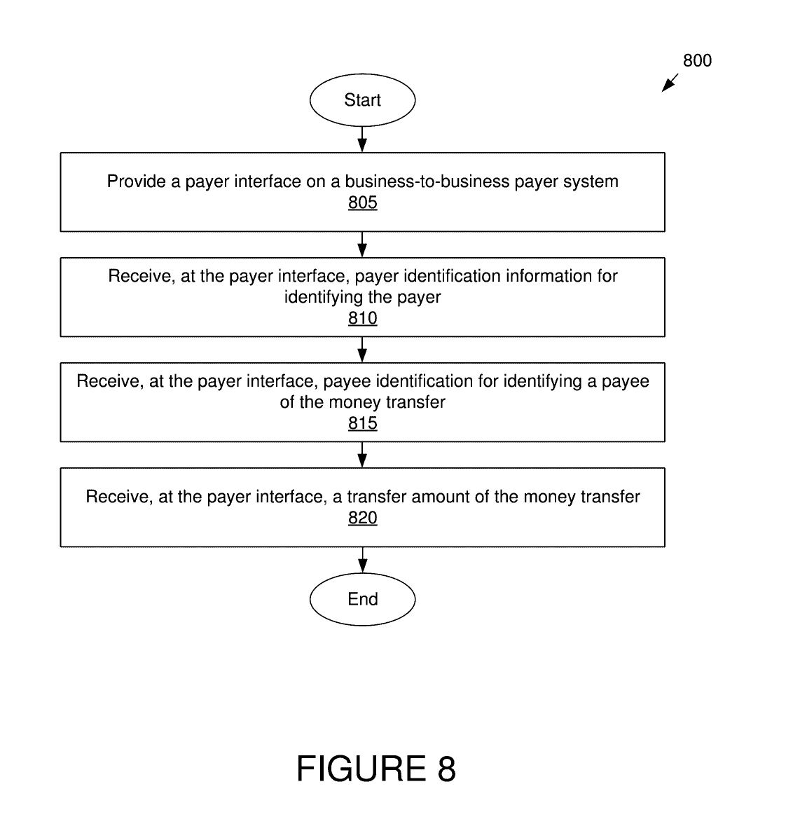

FIG. 8 depicts a flowchart 800 of an example of a method of setting up a payer account to access a payer interface. The flowchart 800 is discussed in conjunction with the structures shown in FIG. 5 and FIG. 6. It is noted other structures may enable and/or provide written description for the blocks of the flowchart 800. It is noted some implementations may include more or less conceptual or functional blocks than those shown in FIG. 8.

The flowchart 800 starts at block 805 where a payer interface is provided to a business-to-business payer system. The payer interface may comprise a portion of a webpage, a portion of a standalone application, a portion of a mobile application, etc. In some implementations, the payer interface management engine 605 may provide a payer interface on a business-to-business payer system. The payer interface may be created using instructions from the payer interface creation engine 640 and/or other modules described herein. The payer interface may be configured to receive input from a payer, as described further herein.

The flowchart 800 continues to block 810 where payer identification information for identifying the payer is received at the payer interface. A payer may provide payer identification information to identify the payer through a payer interface on a business-to-business payer system. In various implementations, the payer identification information comprises a payer's username, given name(s), account numbers, identification numbers, etc. In some implementations, the payer account interface engine 645 may gather a payer interface, at which payer identification information for identifying the payer may be received. The payer account interface engine 645 may store payer information in the payer account datastore 650. The payer account interface engine 645 may provide information related to the payer interface to one or more other modules described herein.

The flowchart 800 continues to block 815 where payee identification for identifying a payee of the money transfer is received at the payer interface. The payee identification engine 680 may gather a payment file from a payment file datastore, using, e.g., the payment file gathering engine 675. The payee identification engine 680 may parse the payment file to obtain a payee identifier of a payee. The payee identifier may comprise a payee name, a payee identification number, etc.

The flowchart 800 continues to block 820 where a transfer amount of the money transfer is identified. The fund transfer parameter identification engine 685 may identify one or more transfer amounts of the money transfer. Instructions may be provided to reconcile amounts owed between financial institutions using the transfer amounts.

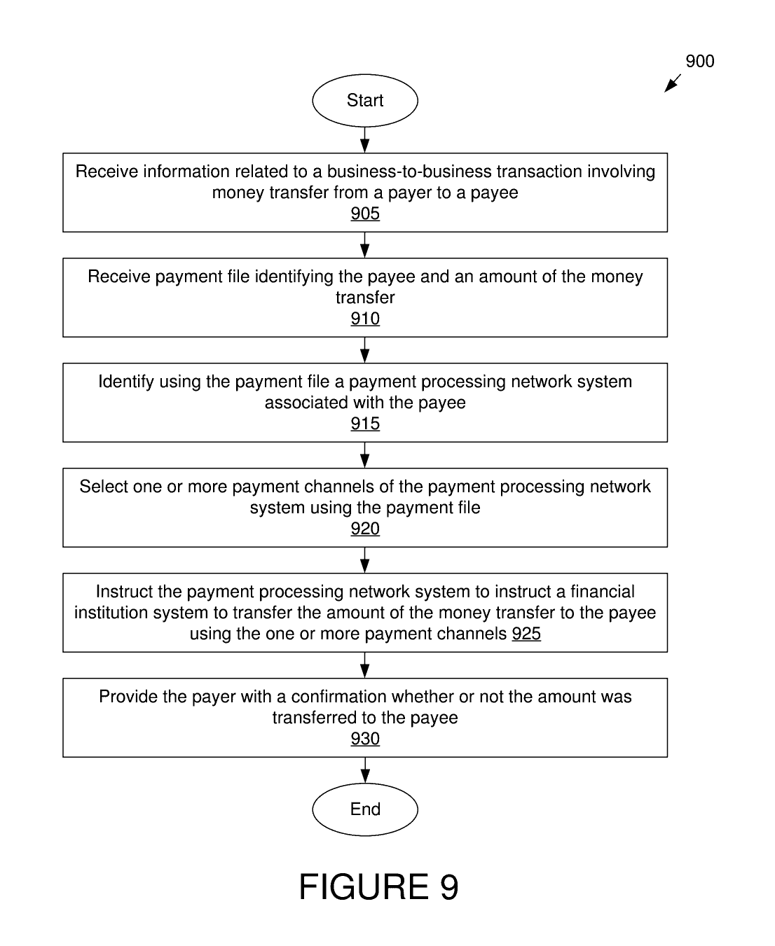

FIG. 9 depicts a flowchart 900 of an example of a method of routing money for a business-to-business transaction over one or more payment processing network systems. The flowchart 900 is discussed in conjunction with the structures shown in FIG. 5 and FIG. 6. It is noted other structures may enable and/or provide written description for the blocks of the flowchart 900. It is noted some implementations may include more or less conceptual or functional blocks than those shown in FIG. 9.

The flowchart 900 starts at block 905 where information related to a business-to-business transaction involving a money transfer from a payer to a payee is received. In various implementations, the payer interface gathering engine 655 may gather a payer interface, which in turn may receive information related to a business-to-business transaction that involves a money transfer form a payer to a payee. The information may comprise a request to initiate the money transfer and/or other information related to the money transfer. The information may comprise instructions to identify a payment file for the money transfer. As noted herein, the payment file may contain payee information, amounts of the money transfer, and/or other parameters of the money transfer. In an implementation, the payment file identifies the payee, and the amount of the money transfer is provided after instructions to initiate the money transfer have been received.

The flowchart 900 continues to block 910 where a payment file that identifies the payee and an amount of the money transfer is received. The payment file management engine 660 may receive (e.g., gather) a payment file from a payment file datastore. The payment file management engine 660 provide the payment file to other modules of the payment routing engine 615, such as, without limitation, the financial institution lookup engine 665 and the payment processing network interface engine 670.

The flowchart 900 continues to block 915 where the payment file is used to identify a payment processing network associated with a payee. The payment file management engine 660 may extract relevant information about a fund transfer to a payee from the payment file, such as information about identifiers, access parameters, etc. of a payment processing network associated with a payee.

The flowchart 900 continues to block 920 where one or more payment channels of the payment processing network system are selected using the payment file. The payment file management engine 660 may identify one or more payment channels of the payment processing network system identified in the payment file provided to it.

The flowchart 900 continues to block 925 where the payment processing network system may be instructed to instruct a financial institution system to transfer the amount of the money transfer to the payee using the one or more payment channels. While in some implementations, the financial institution lookup engine 665 looks up financial institutions for transferring the amount, in other implementations, the payment processing network interface engine 670 instructs the payment processing network to instruct a financial institution system to transfer the amount of the money transfer to the payee using the one or more payment channels.

The flowchart 900 continues to block 930 where the payer is provided with a confirmation whether the amount was transferred to the payee. The payer interface management engine 605 may provide a business-to-business payer system with a confirmation whether or not the amount was transferred to the payee

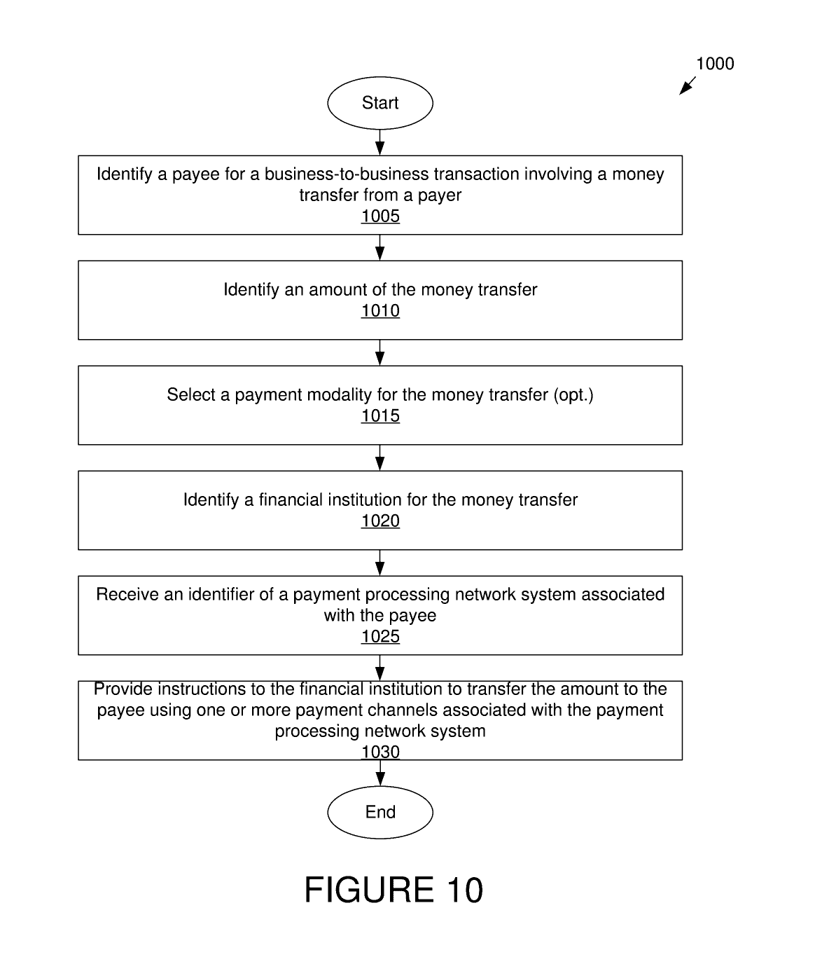

FIG. 10 depicts a flowchart 1000 of an example of a method of allowing a business-to-business payer to provide money for a business-to-business transaction over one or more payment processing network systems. The flowchart 1000 is discussed in conjunction with the structures shown in FIG. 5 and FIG. 6. It is noted other structures may enable and/or provide written description for the blocks of the flowchart 1000. It is noted some implementations may include more or less conceptual or functional blocks than those shown in FIG. 10.

The flowchart 1000 starts at block 1005 where a payee for a business-to-business transaction involving a money transfer from a payer is identified. After receiving a payment file containing payee identification information and/or other information, the payment file gathering engine 675 may provide the payment file to the payee identification engine 680 and/or other modules. The payee identification engine 680 may parse the payment file for payee identification information (payee names, payee usernames, payee email addresses, payee identification numbers, etc.). The payee identification information may be provided to one or more other modules of the payment interface management engine 600, such as one or more modules of the payment routing engine 615.

The flowchart 1000 continues to block 1010 where an amount of the money transfer is identified. The fund transfer parameter identification engine 685 may obtain from a payer system the amount of the money transfer. The fund transfer parameter identification engine 685 may provide the amount of the money transfer to other modules of the payment interface management engine, such as one or more modules of the payment routing engine 615. At an operation 1015, a payment modality for the money transfer may be selected. The fund transfer parameter identification engine 685 may identify a payment modality for the money transfer, using information from the payer and/or information from the payment file. The payment modality may specify specific mechanisms of a payment processing network used to effect the funds transfer.

The flowchart 1000 continues to block 1020 where a financial institution for the money transfer is identified. The financial institution lookup engine 665 may identify a financial institution for the money transfer. In some implementations, the financial institution lookup engine 665 reviews the payment file for identifiers of financial institutions that correspond to specific payees. The financial institution lookup engine 665 may provide identifiers of relevant financial institutions to one or more other modules of the payment interface management engine 600, such as one or more modules of the payment routing engine 615. It is noted that in some implementations, a financial institution need not be identified, but rather may be inferred from the payee information and/or the parameters provided to effect the money transfer by a relevant payment processing network.

The flowchart 1000 continues to block 1025 where an identifier of a payment processing network system associated with the payee is identified. The payment processing network interface engine 670 may identify, based on information in the payment file, a payment processing network for effecting the money transfer. At an operation 1030, instructions to the financial institution to transfer the amount to the payee using one or more payment channels associated with the payment processing network system may be provided. The payment processing network interface engine 670 may provide instructions to the payment processing network to, in turn, instruct a financial institution to transfer money to a payee.

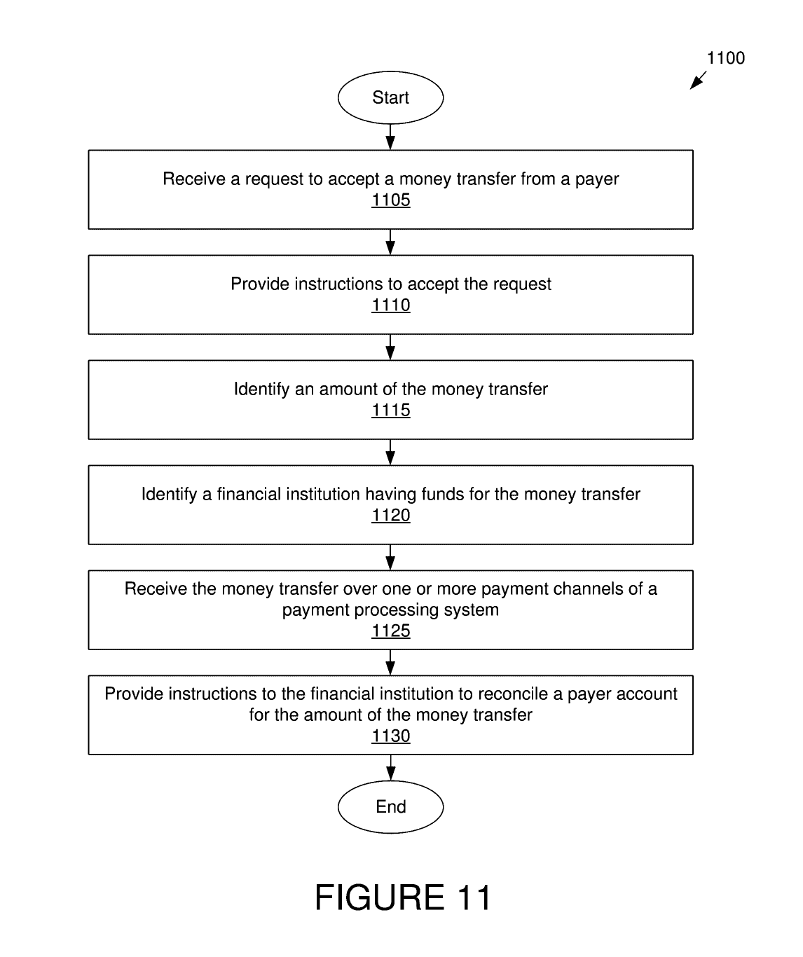

FIG. 11 depicts a flowchart 1100 showing an example of a method of allowing a business-to-business payee to receive money for a business-to-business transaction over one or more payment processing network systems. The flowchart 1100 is discussed in conjunction with the structures shown in FIG. 5 and FIG. 6. It is noted other structures may enable and/or provide written description for the blocks of the flowchart 1100. It is noted some implementations may include more or less conceptual or functional blocks than those shown in FIG. 11.

The flowchart 1100 starts at block 1105 where a request to accept a money transfer from a payer may be received. In various implementations, the payer interface gathering engine 655 may receive one or more requests to transfer money to a payee from a payer.

The flowchart 1100 continues to block 1110 where instructions to accept the request are provided. The payer interface supported by the payer interface gathering engine 655 may provide instructions to accept and/or deny the request.

The flowchart 1100 continues to block 1115 where an amount of the money transfer is identified. The fund transfer parameter identification engine 685 may identify an amount of the money transfer.

The flowchart 1100 continues to block 1120 where a financial institution having funds for the money transfer is identified. The financial institution lookup engine 665 may identify one or more financial institutions that have funds for the money transfer.

The flowchart 1100 continues to block 1125 where the money transfer is received over one or more payment channels of a payment processing system. The payment processing network interface engine 670 may receive a notification that the money transfer was received by a payee financial institution over one or more payment channels of a payment processing network.

The flowchart 1100 continues to block 1130 where instructions are provided to the financial institution to reconcile a payer account for the amount of the money transfer. The reconciliation instruction engine 690 may provide instructions to the financial institution to reconcile a payer account for the amount of the money transfer.

### Example Computer System

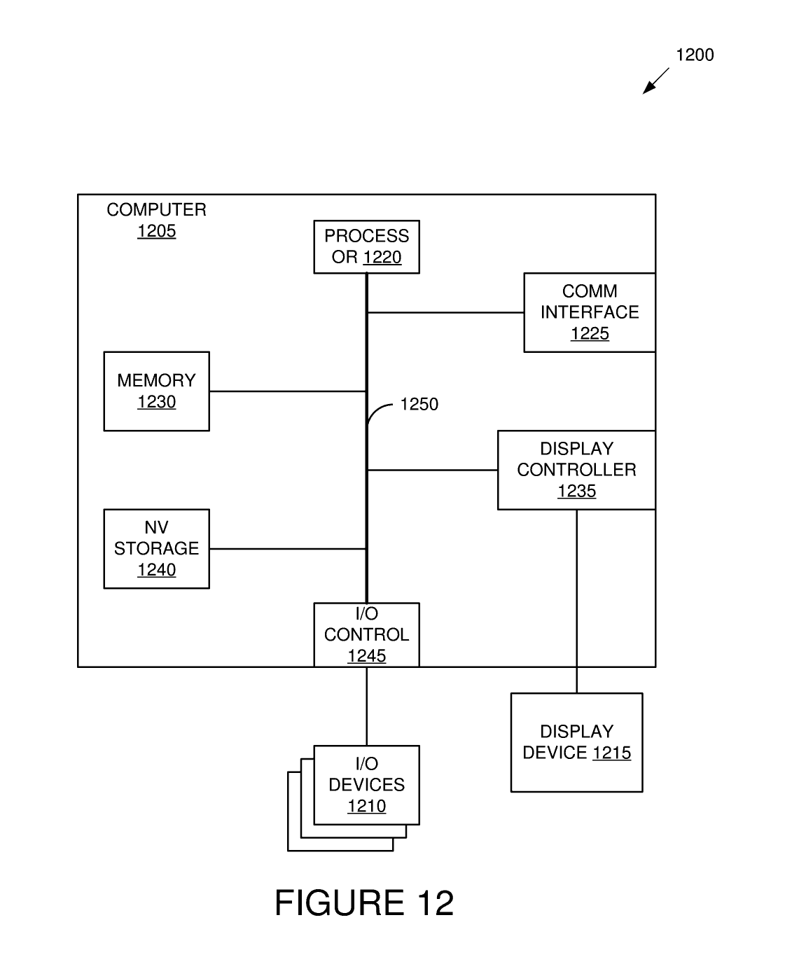

FIG. 12 shows an example of a computer system 1200, which can be incorporated into various implementations described in this paper, and modified in accordance with the techniques described previously. The example of FIG. 12, is intended to illustrate a computer system that can be used as a client computer system, such as a wireless client or a workstation, or a server computer system. In the example of FIG. 12, the computer system 1200 includes a computer 1205, I/O devices 1210, and a display device 1215. The computer 1205 includes a processor 1220, a communications interface 1225, memory 1230, display controller 1235, non-volatile storage 1240, and I/O controller 1245. The computer 1205 can be coupled to or include the I/O devices 1210 and display device 1215.

The computer 1205 interfaces to external systems through the communications interface 1225, which can include a modem or network interface. It will be appreciated that the communications interface 1225 can be considered to be part of the computer system 1200 or a part of the computer 1205. The communications interface 1225 can be an analog modem, ISDN modem, cable modem, token ring interface, satellite transmission interface (e.g. “direct PC”), or other interfaces for coupling a computer system to other computer systems.

The processor 1220 can be, for example, a conventional microprocessor such as an Intel Pentium microprocessor or Motorola power PC microprocessor. The memory 1230 is coupled to the processor 1220 by a bus 1220. The memory 1230 can be Dynamic Random Access Memory (DRAM) and can also include Static RAM (SRAM). The bus 1220 couples the processor 1220 to the memory 1230, also to the non-volatile storage 1240, to the display controller 1235, and to the I/O controller 1245.

The I/O devices 1210 can include a keyboard, disk drives, printers, a scanner, and other input and output devices, including a mouse or other pointing device. The display controller 1235 can control in the conventional manner a display on the display device 1215, which can be, for example, a cathode ray tube (CRT) or liquid crystal display (LCD). The display controller 1235 and the I/O controller 1245 can be implemented with conventional well known technology.

The non-volatile storage 1240 is often a magnetic hard disk, an optical disk, or another form of storage for large amounts of data. Some of this data is often written, by a direct memory access process, into memory 1230 during execution of software in the computer 1205. One of skill in the art will immediately recognize that the terms “machine-readable medium” or “computer-readable medium” includes any type of storage device that is accessible by the processor 1220 and also encompasses a carrier wave that encodes a data signal.

The computer system illustrated in FIG. 12 can be used to illustrate many possible computer systems with different architectures. For example, personal computers based on an Intel microprocessor often have multiple buses, one of which can be an I/O bus for the peripherals and one that directly connects the processor 1220 and the memory 1230 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1230 for execution by the processor 1220. A Web TV system, which is known in the art, is also considered to be a computer system, but it can lack some of the features shown in FIG. 12, such as certain input or output devices. A typical computer system will usually include at least a processor, memory, and a bus coupling the memory to the processor.

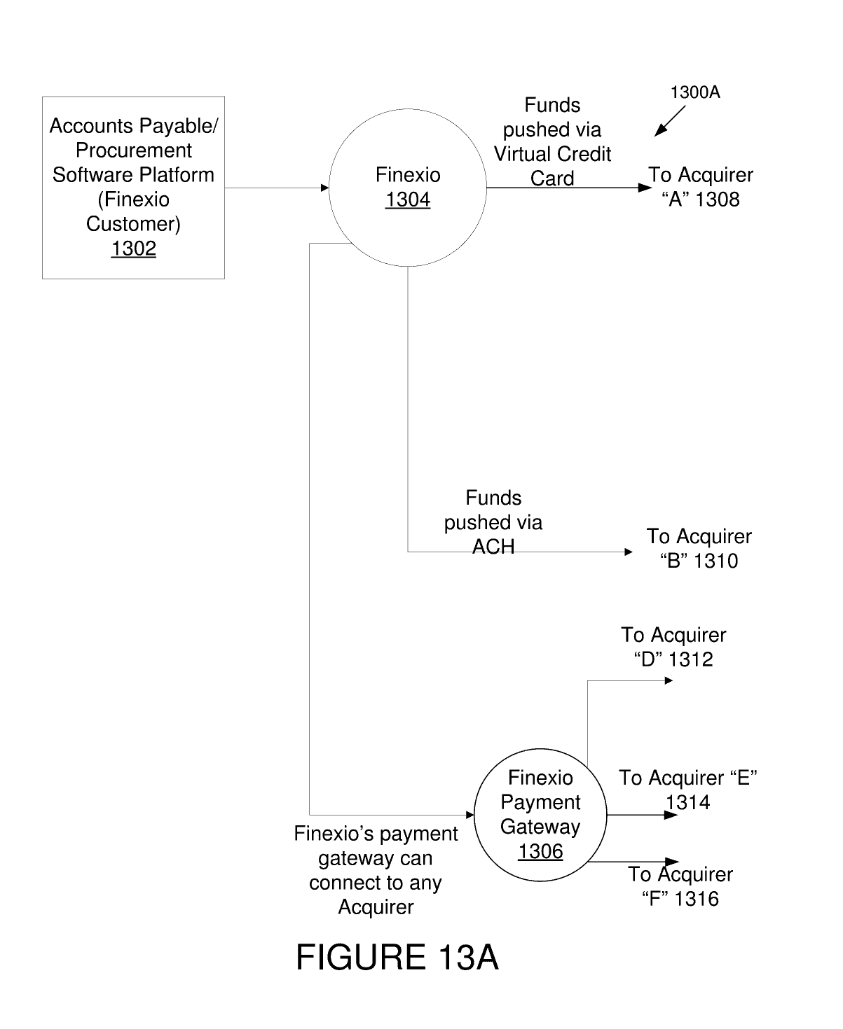

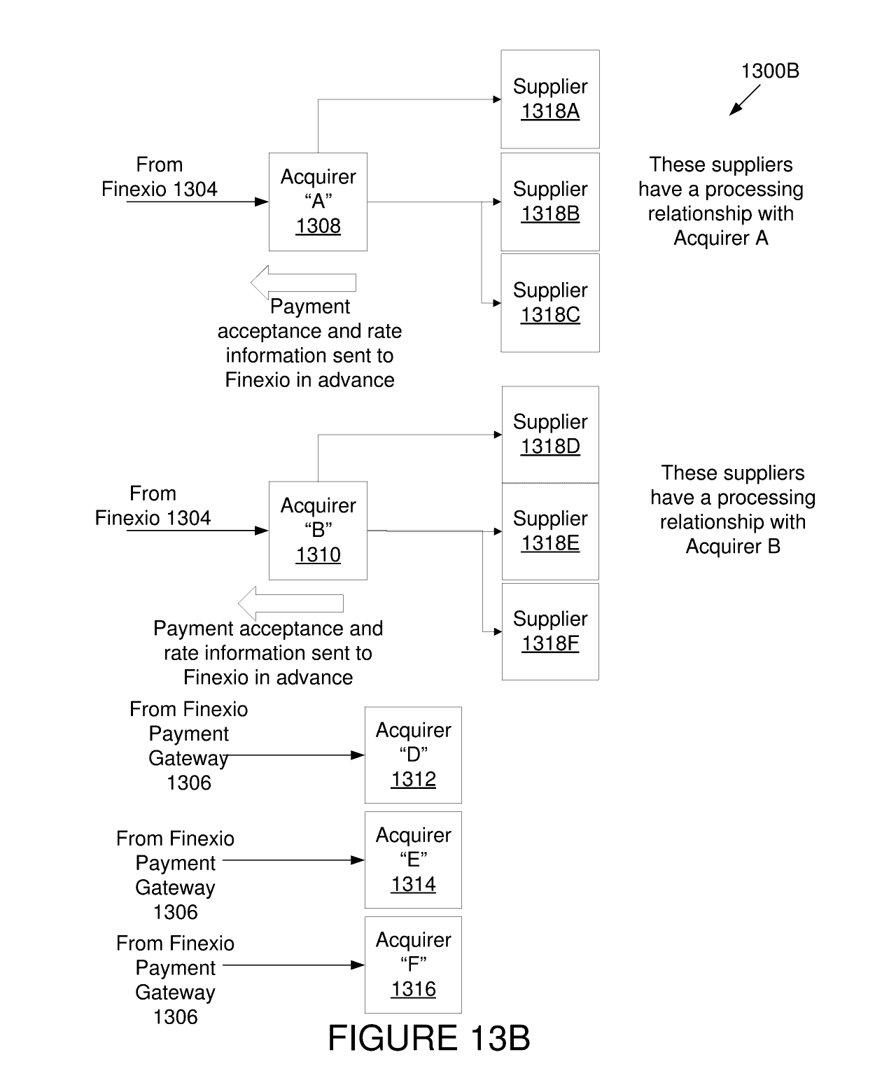

FIGS. 13A and 13B depict a flowchart 1300 of an example of a method of directing payments from a accounts payable/procurement software platform to one or more suppliers and/or one or more acquirers. At an operation 1302, information about a purchase may be received at an accounts payable/procurement payment platform. The accounts payable/procurement payment platform may correspond to a platform accessed by a customer making payments using the systems and methods described herein. At an operation 1304, an automated hub payments processing hub system may receive a payment request from the accounts payable/procurement payment platform to pay a specific supplier. The automated hub payments processing hub system may analyze the payment request to determine where in its network the supplier is located. The automated hub payments processing hub system may determine how to make the payment and based on the modality may understand the price the supplier will be willing to pay for the transaction. Each merchant acquirer may utilize proprietary systems and/or tools to complete the transaction at lower rates by working with the automated hub payments processing hub system. These could be based on data inclusion or by payment type. Information about the payment may be communicated back to the customer before execution. If the supplier is not located within the closed loop network of automated hub payments processing hub system, the automated hub payments processing hub system can use integrated gateway functionalities that are connected to several other merchant acquirers. The funds may be pushed from the automated hub payments processing hub system to acquirers (e.g., to acquirer A 1308, acquirer B 1310, etc.). acquirer D 1312, acquirer 1314, and acquirer 1316. At an operation 1306, the automated hub payments processing hub system's payment gateway may push funds to acquirers (acquirer D 1312, acquirer E 1314, acquirer F 1316, etc.).

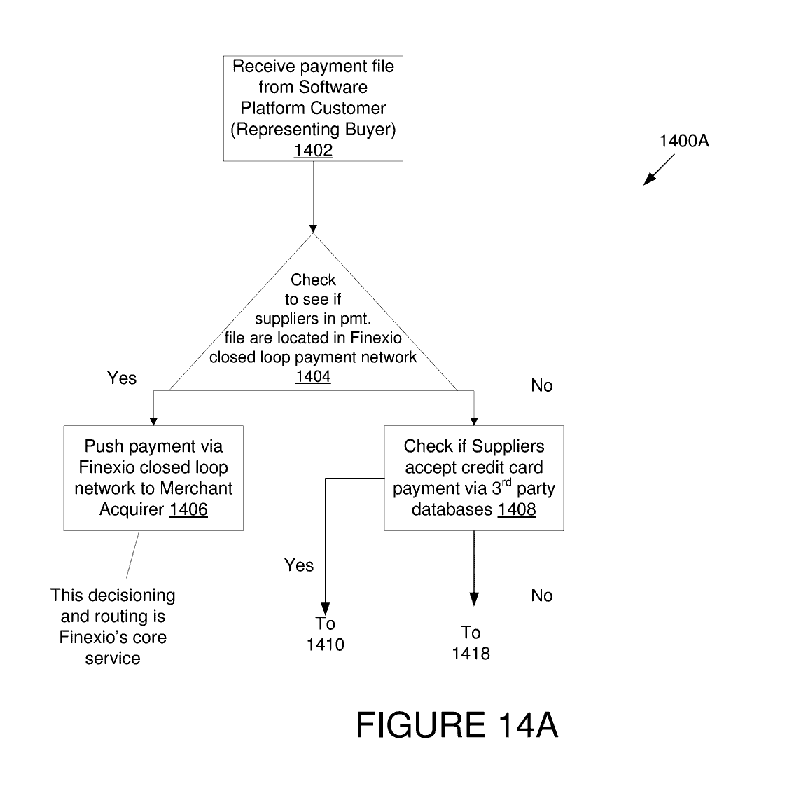

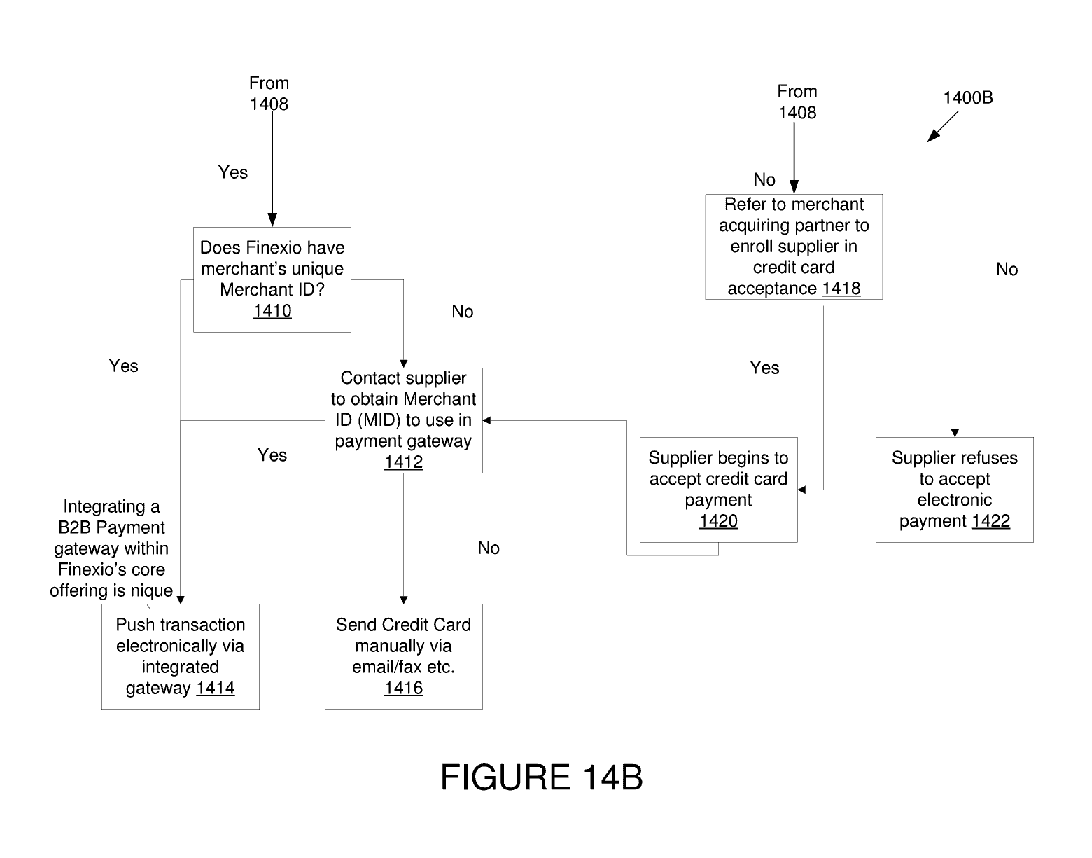

FIGS. 14A and 14B depict a flowchart of an example of a method of directing payments from a buyer to one or more merchants. At an operation 1402, a payment file may be received from a software platform customer (that represents buyer). At an operation 1404, it may be checked to see if suppliers in a payment file are file are located in a closed loop payment network maintained by an automated payments processing hub system. At an operation 1406, the payment may be pushed via the automated payments processing hub system to a merchant acquirer. At an operation 1408, it may be checked to see if suppliers accept credit cards via third party databases. At an operation 1410, it may be checked to see if the automated payments processing hub system has a unique merchant ID. At an operation 1412, the supplier may be contacted to obtain a merchant ID to use in a payment gateway. At an operation 1414, the transaction may be pushed electronically via the integrated gateway. At an operation 1416, the credit card may be sent manually vie email/fax etc. At an operation 1418, it may be referred to the merchant acquiring partner to enroll a supplier in a credit card acceptance. At an operation 1420, the supplier may begin to accept credit card payments. At an operation 1422, the supplier may refuse to accept electronic payments.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the implementations is intended to be illustrative, but not limiting, of the scope, which is set forth in the claims recited herein.

What is claimed is:

1. A system comprising:
a payment interface gathering engine configured to receive information related to a business-to-business transaction involving money transfer from a payer to a payee;
a payment file gathering engine configured to gather a payment file identifying the payee and a fund transfer amount of the money transfer;
a payment processing network interface engine configured to identify, using the payment file, a payment processing network system associated with the payee, to select one or more payment channels of the payment processing network system using the payment file, and to instruct the payment processing network system to transfer, using a financial institution system, the fund transfer amount of the money transfer to the payee using the one or more payment channels;
a payer interface management engine configured to provide the payer with a payer interface to facilitate confirmation the fund transfer amount was transferred to the payee.

2. The system of claim 1, wherein the payment file includes payee identification information, a fund transfer amount, and an identifier of the payment processing network system.

3. The system of claim 1, wherein the payer interface does not display an identity of the payment processing network to the payer.

4. The system of claim 1, further comprising a payment file management engine configured to identify a payment modality associated with the payment processing network, the payment modality configured to specify a funds transfer mechanism for the money transfer.

5. The system of claim 1, wherein the payer interface management engine comprises a payer interface creation engine configured to create the payer interface for the payer using payee information provided by the payer.

6. The system of claim 1, further comprising a payer account management engine configured to create a payer account for using the payer interface.

7. The system of claim 1, further comprising a payee interface engine configured to:
review the payment file;
identify the payee based on information in the payment file;
provide, based on the information in the payment file, instructions to the payment processing network to instruct a payer financial institution associated with the payer and a payee financial institution associated with the payee to reconcile the fund transfer amount.

8. The system of claim 7, wherein the payee interface engine is configured to identify one or more fund transfer parameters associated with the money transfer, the one or more fund transfer parameters providing a basis to identify the fund transfer amount and the payment processing network.

9. The system of claim 1, wherein the payment processing network comprises an Automated Clearinghouse (ACH) network configured to facilitate transfer of the fund transfer amount from a payer financial institution associated with the payer and a payee financial institution associated with the payee.

10. The system of claim 1, wherein the confirmation comprises a notification in the payer interface.

11. The system of claim 1, wherein the payer interface comprises an interface incorporated into a webpage, a mobile application, or a standalone application.

12. A method comprising:
receiving information related to a business-to-business transaction involving money transfer from a payer to a payee;
receiving a payment file identifying the payee and an amount of the money transfer;
identifying, using the payment file, a payment processing network system associated with the payee;
selecting one or more payment channels of the payment processing network system using the payment file;
instructing the payment processing network system to transfer, using a financial institution system, the amount of the money transfer to the payee using the one or more payment channels;
providing the payer with a confirmation the amount was transferred to the payee.

13. The method of claim 12, wherein the payment file includes payee identification information, a fund transfer amount, and an identifier of the payment processing network system.

14. The method of claim 12, wherein the payer interface does not display an identity of the payment processing network to the payer.

15. The method of claim 12, further comprising identifying a payment modality associated with the payment processing network, the payment modality configured to specify a funds transfer mechanism for the money transfer.

16. The method of claim 12, further comprising creating the payer interface for the payer using payee information provided by the payer.

17. The method of claim 12, further comprising creating a payer account for using the payer interface.

18. The method of claim 12, further comprising:
reviewing the payment file;
identifying the payee based on information in the payment file;
providing, based on the information in the payment file, instructions to the payment processing network to instruct a payer financial institution associated with the payer and a payee financial institution associated with the payee to reconcile the fund transfer amount.

19. The method of claim 18, wherein the payee interface engine is configured to identify one or more fund transfer parameters associated with the money transfer, the one or more fund transfer parameters providing a basis to identify the fund transfer amount and the payment processing network.

20. The method of claim 12, wherein the payment processing network comprises an Automated Clearinghouse (ACH) network configured to facilitate transfer of the fund transfer amount from a payer financial institution associated with the payer and a payee financial institution associated with the payee.

21. The method of claim 12, wherein the confirmation comprises a notification in the payer interface.

22. The method of claim 12, wherein the payer interface comprises an interface incorporated into a webpage, a mobile application, or a standalone application.

23. A system comprising:
one or more processors;
memory coupled to the one or more processors, the memory configured to store computer program instructions, the computer program instructions configured to execute a computer-implemented method, the computer-implemented method comprising:
receiving information related to a business-to-business transaction involving money transfer from a payer to a payee;
receiving a payment file identifying the payee and an amount of the money transfer;
identifying, using the payment file, a payment processing network system associated with the payee;
selecting one or more payment channels of the payment processing network system using the payment file;
instructing the payment processing network system to transfer, using a financial institution system, the amount of the money transfer to the payee using the one or more payment channels;
providing the payer with a confirmation the amount was transferred to the payee.
